(19) United States
(12) Patent Application Publication
(10) Pub. No.: US 2012/0291228 A1
(43) Pub. Date: Nov. 22, 2012

(54) Sling Retainer

(76) Inventor: Richard Dean Toth, Colorado Springs, CO (US)

(21) Appl. No.: 13/110,803

(22) Filed: May 18, 2011

(51) Int. Cl. F16B 2/20; A45F 5/00

(52) U.S. Cl. 24/3.12; 24/3.1

(57) ABSTRACT

A rifle sling retainer comprising an elongated curved base plate for bearing a flexible gun sling strap and having a body and first and second end portions where the first end portion is bent at an angle to the base plate for preventing the flexible strap from moving laterally in the direction of the said first end portion. The retainer can be attached to clothing or constructed in the form of a clip to be attached to the shoulder strap of a back pack.

### SUMMARY OF THE INVENTION

Rifles, shotguns, tactical weapons, cameras and bags are often equipped with a flexible sling whose ends are attached to spaced apart points on the object to be carried and whose intermediate portion is adapted to be placed over the shoulder of the person carrying the object. Unfortunately, the contour of most human shoulders is not disposed to assume the function of a bracket and the carrying slings tend to work their way off the shoulder. Some slings incorporate rubberized coatings on the shoulder contacting surface of the sling material in order to increase the friction between the sling and the clothing being worn by the carrier, but this solution is minimally effective.

It is therefore, the principal object of the present invention to provide a structural sling retainer that can be secured in fixed position on the shoulder of the one carrying a gun or other device by means of a shoulder sling.

### DESCRIPTION OF THE DRAWINGS

FIG. 1 is a perspective view of a person carrying a rifle having a sling where the sling is retained on the shoulder of the person by a preferred form of the present invention, as shown in more detail in FIGS. 3 and 4.

FIG. 2 is perspective view of a person with a back pack and also carrying a rifle having a sling where the sling is retained on the shoulder of the person by an alternative form of the present invention as shown in more detail in FIGS. 5, 6 and 7.

FIG. 3 is a perspective view of the basic or preferred form of the sling retainer.

FIG. 4 is a side view of the preferred form of the present invention showing a flexible sling in cross section.

FIG. 5 is a perspective view of the alternative form of the present invention.

FIG. 6 is a perspective view showing the alternative embodiment of the invention with a back pack strap and sling strap shown fragmentarily and in cross section.

FIG. 7 is a side view of the alternative embodiment showing the back pack strap and sling in cross section as they would appear in their respective positions on the retainer.

### DETAILED DESCRIPTION OF PREFERRED EMBODIMENT

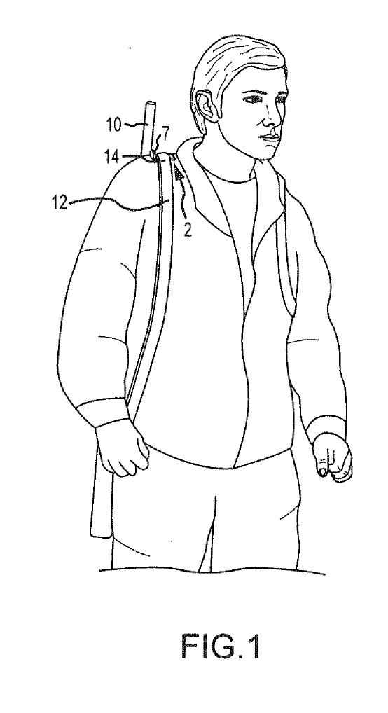

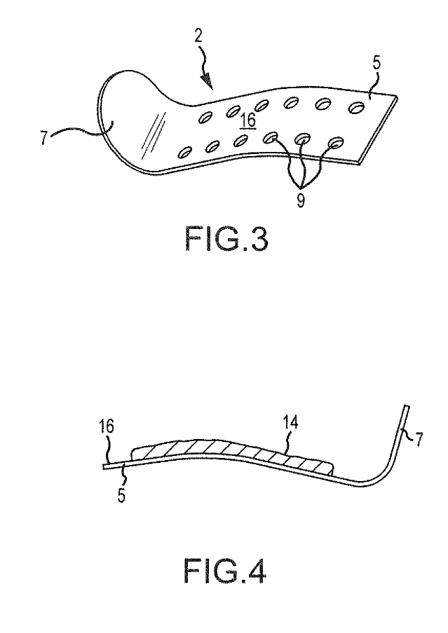

The basic form of the sling retainer of the present invention is shown in FIGS. 1, 3 and 4. The retainer 2 comprises an elongated base plate 5, preferably of metal construction, that has one of its ends 7 bent upwardly to a position approximately perpendicular to the base. A plurality of holes 9 in the base are provided for receiving thread or other appropriate devices for fastening the retainer to the shoulder portion of the outer clothing worn by the person carrying the rifle 10. Instead of holes for receiving thread, a plurality of larger holes could receive screws or studs to fasten the retainer onto sturdy material such as leather, for example. As seen in FIG. 1, a rifle 10 is equipped with a flexible carrying sling 12 whose ends are attached to spaced apart points on the rifle and whose intermediate section 14 is adapted to drape over the shoulder of the person carrying the rifle, shotgun or other baggage. In order that the sling 12 will not work its way off of the shoulder, the intermediate portion 14 of the sling rests upon and bears against the top portion 16 of the base plate 5 of the retainer 2. The up-turned end 7 of the retainer keeps the intermediate portion 14 of the sling 12 from working its way off the shoulder of the gun carrier person.

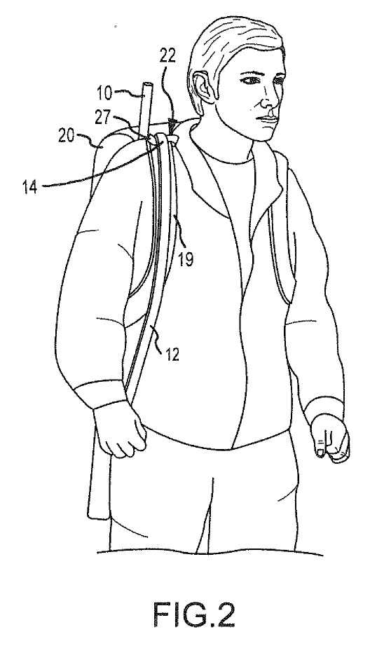

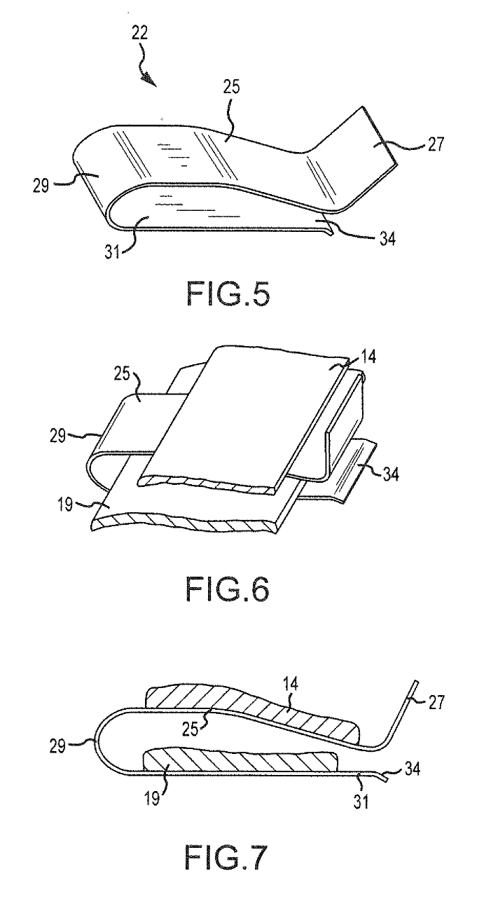

As an alternative to sewing or otherwise fastening the sling retainer to clothing, a second embodiment of the invention contemplates clipping the retainer to the shoulder strap 19 of a back pack 20. The second embodiment is shown in FIGS. 2, 5, 6 and 7. The alternative retainer 22 comprises a base plate 25 with an up-turned end 27, similar to the base plate 5 and up-turned end 7 of the first embodiment. The end 29 of the base plate that opposes the up-turned end 27 is bent to form a reverse bottom leg 31 that underlies the base plate 25. The material out of which the alternative retainer is constructed is preferably metal that possesses springable qualities in order that the terminal end 34 of the bottom leg 31 will be spring biased toward the underside of the base plate 25. Other material, such as plastic can also be used. The interaction between the spring biased leg 31 and the base plate 25 provides a spring clip which tightly embraces a section of the shoulder strap 19 of the back pack 20, as shown in FIGS. 2 and 6. The intermediate portion 14 of the gun sling 12 rests on or bears against the top surface of the base plate 25 wile the up-turned end 27 of the retainer serves as a stop maintaining the sling in position on the shoulder.

What is claimed is:

1. A shoulder sling retainer comprising,
an elongated curved base plate for bearing a flexible sling strap and having a body and first and second end portions where the first end portion is bent at an angle to the base plate for preventing the flexible strap from moving laterally in the direction of the said first end portion.

2. The sling retainer of claim 1 where the body of the base plate includes a plurality of aperture means for receiving fastening material.

3. The sling retainer of claim 1 where the second end portion includes a reverse bend leg underlying and spaced from the base plate to form a clip.
